(19) United States
(12) Patent Application Publication
(10) Pub. No.: US 2026/0056570 A1
(43) Pub. Date: Feb. 26, 2026

(54) HIGH-PRECISION CURRENT SOURCE AND ELECTRONIC DEVICE

(71) Applicant: SUZHOU C*Core Technology Co., Ltd., Suzhou (CN)

(72) Inventors: Jiang ZHENG, Suzhou (CN); Xin XU, Suzhou (CN); Xiuqiang XU, Suzhou (CN); Zuonan XIAO, Suzhou (CN); Qihe KUANG, Suzhou (CN)

(21) Appl. No.: 19/306,470

(22) Filed: Aug. 21, 2025

(30) Foreign Application Priority Data
Aug. 22, 2024 (CN) 202411157416.4

(51) Int. Cl. G05F 3/26

(52) U.S. Cl. CPC G05F 3/262

(57) ABSTRACT

A high-precision current source and an electronic device applied in the field of high-precision circuit design. An inverting input terminal, a non-inverting input terminal and an output terminal of a first operational amplifier are connected to a bias voltage terminal, a first terminal of a zero temperature coefficient resistor circuit and a first terminal of the first transistor, respectively; second and third terminals of the first transistor are connected to a power supply of a chip and a second terminal of the zero temperature coefficient resistor circuit, respectively; third and fourth terminals of the zero temperature coefficient resistor circuit are connected to a signal control terminal and a first terminal of a current generation circuit, respectively, and a second terminal of the current generation circuit is connected to a corresponding external circuit.

### CROSS-REFERENCE TO RELATED APPLICATION

The present application claims priority to Chinese patent application No. 202411157416.4, filed on Aug. 22, 2024, entitled “HIGH-PRECISION CURRENT SOURCE AND ELECTRONIC DEVICE”, which is incorporated herein by reference in its entirety.

### TECHNICAL FIELD

The present disclosure relates to the field of high-precision circuit design, in particular to a high-precision current source and an electronic device.

### BACKGROUND

In an airbag ignition circuit, if the ignition current precision is poor, it may lead to false ignition, missed ignition, or delayed ignition of the airbag. Therefore, the precision of the ignition current directly affects the function of the airbag, thereby affecting its protection effect on a driver and passenger(s).

In the ignition circuit, all the current is sourced from an internal current source. The existing current source circuit is shown in FIG. 1, and includes an operational amplifier OP1, transistors MN1, MN2, MN3 and MN4, and a resistor R1. A non-inverting input terminal of the operational amplifier OP1 is connected to a bias voltage source inside a chip; an inverting input terminal of the operational amplifier OP1 is connected to a first terminal of the resistor R1 and a first terminal of the transistor MN1; an output terminal of the operational amplifier OP1 is connected to a second terminal of the transistor MN1; a second terminal of the resistor R1 is grounded; a third terminal of the transistor MN1 is connected to a first terminal of the transistor MN2, a second terminal of the transistor MN2, a first terminal of the transistor MN3, a first terminal of the transistor MN4, and a first terminal of the transistor MNN; a third terminal of the transistor MN2 is connected to a power supply terminal; second terminals of the transistors MN3, MN4 and MNN are respectively connected to the power supply terminal; third terminals of the transistors MN3, MN4 and MNN serving as output terminals are respectively connected to other circuits and output corresponding currents, where the current output by the transistor MN3 is I<0>, the current output by the transistor MN4 is I<I>, and the current output by the transistor MNN is I<N>. The principle of the circuit is as follows: by utilizing “virtual short” characteristic of the operational amplifier OP1, a voltage at the source of the transistor MN1 is clamped at a reference voltage VREF. The transistors MN1 and MN2, and the resistor R1 form a reference current generation circuit. Ideally, the current IREF of this current source circuit is equal to VREF/R1. However, in order to obtain a high-precision reference current, the resistor R1 needs to use an off-chip high-precision resistor, which will increase the number of pins of the chip and the area of the PCB board, thereby increasing the cost.

In view of the above technologies, it is an urgent problem to be solved by those skilled in the art to seek a high-precision current source.

### SUMMARY

An object of the present disclosure is to provide a high-precision current source and an electronic device, to solve the problem of increasing the number of pins of the entire chip and the area of the PCB board caused by using an external high-precision resistor.

To solve the above technical problem, the present disclosure provides a high-precision current source, including: a reference voltage generation circuit and a current generation circuit, where the reference voltage generation circuit includes: a first operational amplifier, a first transistor, and a zero temperature coefficient resistor circuit;
an inverting input terminal of the first operational amplifier is connected to a bias voltage terminal, a non-inverting input terminal of the first operational amplifier is connected to a first terminal of the zero temperature coefficient resistor circuit, an output terminal of the first operational amplifier is connected to a first terminal of the first transistor, and the first operational amplifier is configured to obtain a bias voltage of the bias voltage terminal and transmit the bias voltage to the zero temperature coefficient resistor circuit;
a second terminal of the first transistor is connected to a power supply of a chip, and a third terminal of the first transistor is connected to a second terminal of the zero temperature coefficient resistor circuit;
a third terminal of the zero temperature coefficient resistor circuit is connected to a signal control terminal, a fourth terminal of the zero temperature coefficient resistor circuit is connected to a first terminal of the current generation circuit, a second terminal of the current generation circuit is connected to a corresponding external circuit, and the zero temperature coefficient resistor circuit is configured to receive a control signal sent by the signal control terminal, adjust the bias voltage according to the control signal, and transmit the adjusted bias voltage to the current generation circuit, such that the current generation circuit outputs the corresponding current according to the adjusted bias voltage.

Preferably, the zero temperature coefficient resistor circuit includes a first resistor module, a second resistor module, a third resistor module, and a resistor string module;
a first terminal of the first resistor module is connected to a first terminal of the resistor string module, and the first terminal of the first resistor module and the first terminal of the resistor string module jointly serve as the second terminal of the zero temperature coefficient resistor circuit and are connected to the third terminal of the first transistor; a second terminal of the first resistor module is connected to a first terminal of the second resistor module, and the second terminal of the first resistor module and the first terminal of the second resistor module jointly serve as the first terminal of the zero temperature coefficient resistor circuit and are connected to the non-inverting input terminal of the first operational amplifier;
a second terminal of the second resistor module is connected to a first terminal of the third resistor module and a second terminal of the resistor string module;
a second terminal of the third resistor module is grounded; and
a third terminal of the resistor string module serves as the third terminal of the zero temperature coefficient resistor circuit and is connected to the signal control terminal, and a fourth terminal of the resistor string module serves as the fourth terminal of the zero temperature coefficient resistor circuit and is connected to the first terminal of the current generation circuit.

Preferably, the resistor string module includes N resistor modules with the same structure;
a first terminal of an initial resistor module serves as the first terminal of the resistor string module and is connected to the first terminal of the first resistor module;
a first terminal of a Xth resistor module is connected to a second terminal of a (X−1)th resistor module;
a second terminal of a Nth resistor module serves as the second terminal of the resistor string module and is connected to the second terminal of the second resistor module and the first terminal of the third resistor module;
a third terminal of each of the resistor modules serves as the third terminal of the resistor string module and is connected to the signal control terminal, such that each of the resistor modules determines a corresponding target resistor module according to the control signal sent by the signal control terminal, and connects a fourth terminal of the target resistor module serving as the fourth terminal of the resistor string module to the first terminal of the current generation circuit;
where N is an integer greater than 0, and X is an integer greater than 1 and less than N.

Preferably, the current generation circuit includes a target current circuit and a mirror current circuit;
a first terminal of the target current circuit serves as the first terminal of the current generation circuit and is connected to the fourth terminal of the zero temperature coefficient resistor circuit; a second terminal of the target current circuit is connected to a first terminal of the mirror current circuit; and
a second terminal of the mirror current circuit serves as the second terminal of the current generation circuit and is connected to the corresponding external circuit.

Preferably, the target current circuit includes: a second operational amplifier, a second transistor, a third transistor, and a fourth resistor module;
a first terminal of the second transistor is connected to the power supply of the chip, and a second terminal of the second transistor is connected to a third terminal of the second transistor and a first terminal of the third transistor;
a non-inverting input terminal of the second operational amplifier serves as the first terminal of the target current circuit and is connected to the fourth terminal of the zero temperature coefficient resistor circuit; an inverting input terminal of the second operational amplifier is connected to a second terminal of the third transistor and a first terminal of the fourth resistor module; an output terminal of the second operational amplifier is connected to a third terminal of the third transistor, and the output terminal of the second operational amplifier and the third terminal of the third transistor jointly serve as the second terminal of the target current circuit and are connected to the first terminal of the mirror current circuit; and
a second terminal of the fourth resistor module is grounded.

Preferably, the mirror current circuit includes M mirror circuits with the same structure, and each mirror circuit of the mirror circuits comprises a first terminal and a second terminal; M is an integer greater than 1;
first terminals of the mirror circuits are connected to each other, serve as the first terminal of the mirror current circuit and are connected to the second terminal of the target current circuit; and
second terminals of the mirror circuits serve as the second terminal of the mirror current circuit and are respectively connected to a corresponding external circuit.

Preferably, the mirror circuit includes: a fourth transistor and a fifth resistor module;
a first terminal of the fourth transistor serves as the first terminal of the mirror circuit and is connected to the second terminal of the target current circuit, a second terminal of the fourth transistor serves as the second terminal of the mirror circuit and is connected to the corresponding external circuit, and a third terminal of the fourth transistor is connected to a first terminal of the fifth resistor module; and
a second terminal of the fifth resistor module is grounded.

Preferably, the first transistor is a first P-type MOS transistor; the second transistor is a second P-type MOS transistor; and the third transistor is a first N-type MOS transistor;
a gate of the first P-type MOS transistor serves as the first terminal of the first transistor and is connected to the output terminal of the first operational amplifier, a source of the first P-type MOS transistor serves as the second terminal of the first transistor and is connected to the power supply of the chip, and a drain of the first P-type MOS transistor serves as the third terminal of the first transistor and is connected to the second terminal of the zero temperature coefficient resistor circuit;
a source of the second P-type MOS transistor serves as the first terminal of the second transistor and is connected to the power supply of the chip; and a gate of the second P-type MOS transistor serving as the second terminal of the second transistor is connected to a drain of the second P-type MOS transistor serving as the third terminal of the second transistor; and
a drain of the first N-type MOS transistor serves as the first terminal of the third transistor and is connected to the gate of the second P-type MOS transistor, a gate of the first N-type MOS transistor serves as the third terminal of the third transistor and is connected to the output terminal of the second operational amplifier, and a source of the first N-type MOS transistor serves as the second terminal of the third transistor and is connected to the first terminal of the fourth resistor module.

Preferably, the fourth transistor is a second N-type MOS transistor;
a gate of the second N-type MOS transistor serves as the first terminal of the fourth transistor and is connected to the second terminal of the target current circuit, a source of the second N-type MOS transistor serves as the second terminal of the fourth transistor and is connected to the corresponding external circuit, and a drain of the second N-type MOS transistor serves as the third terminal of the fourth transistor and is connected to the first terminal of the fifth resistor module.

To solve the above technical problem, the present disclosure also provides an electronic device including the above high-precision current source.

The high-precision current source provided by the present disclosure includes: a reference voltage generation circuit and a current generation circuit, where the reference voltage generation circuit includes: a first operational amplifier, a first transistor, and a zero temperature coefficient resistor circuit; the inverting input terminal of the first operational amplifier is connected to the bias voltage terminal, the non-inverting input terminal of the first operational amplifier is connected to the first terminal of the zero temperature coefficient resistor circuit, and the output terminal of the first operational amplifier is connected to the first terminal of the first transistor, and the first operational amplifier is configured to obtain the bias voltage of the bias voltage terminal and transmit the bias voltage to the zero temperature coefficient resistor circuit; the second terminal of the first transistor is connected to the power supply of the chip, and the third terminal of the first transistor is connected to the second terminal of the zero temperature coefficient resistor circuit; the third terminal of the zero temperature coefficient resistor circuit is connected to the signal control terminal, the fourth terminal of the zero temperature coefficient resistor circuit is connected to the first terminal of the current generation circuit, the second terminal of the current generation circuit is connected to the corresponding external circuit, and the zero temperature coefficient resistor circuit is configured to receive the control signal sent by the signal control terminal, adjust the bias voltage according to the control signal, and transmit the adjusted bias voltage to the current generation circuit, such that the current generation circuit outputs the corresponding current according to the adjusted bias voltage. It can be seen that, in the present disclosure, it reduces the influence of chip manufacturing process and operating voltage on the precision of the current source by slightly adjusting the bias voltage, and it uses resistors with different temperature coefficients to form a zero temperature coefficient resistor, which reduces the problem of the drift of the output current due to the change of temperature, avoids the use of an external high-precision resistor and improves the precision of the current source.

### BRIEF DESCRIPTION OF THE DRAWINGS

To more clearly illustrate the embodiments of the present disclosure, the accompanying drawings which need to be used in the embodiments will be introduced briefly below. Obviously, the drawings described below are only some embodiments of the present disclosure. For those skilled in the art, other drawings can also be obtained according to these drawings without any creative effort.

FIG. 1 is a circuit diagram of a current source provided in the prior art;

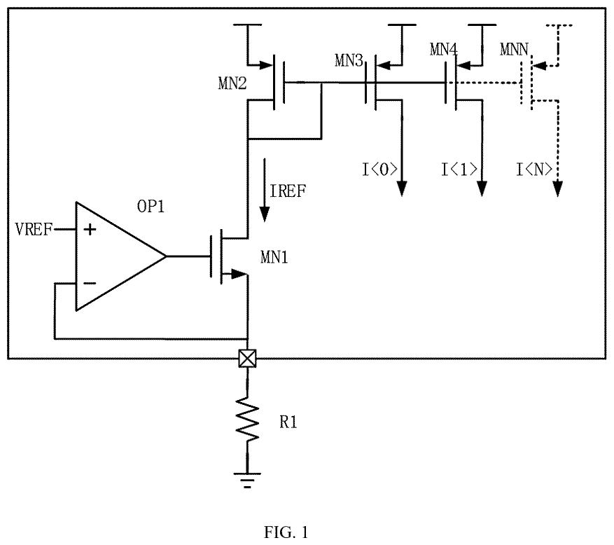

FIG. 2 is a circuit diagram of a high-precision current source provided in an embodiment of the present disclosure;

FIG. 3 is a simulation curve of the resistance value of a positive temperature coefficient resistor changing with temperature provided in an embodiment of the present disclosure;

FIG. 4 is a simulation curve of the resistance value of a negative temperature coefficient resistor changing with temperature provided in an embodiment of the present disclosure;

FIG. 5 is a simulation curve of the resistance value of a zero temperature coefficient resistor circuit changing with temperature provided in an embodiment of the present disclosure; and

FIG. 6 is a complete circuit diagram of a high-precision current source provided in an embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are merely a part but not all of the embodiments of the present disclosure. Based on the embodiments in the present disclosure, all the other embodiments obtained by those skilled in the art without any creative effort shall all fall within the protection scope of the present disclosure.

The core of the present disclosure is to provide a high-precision current source and an electronic device.

In order to enable those skilled in the art to better understand the solution of the present disclosure, the present disclosure will be further described in detail below with reference to the accompanying drawings and specific embodiments.

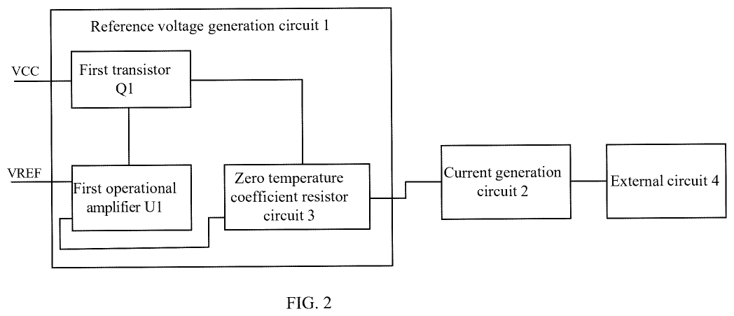

To solve the above technical problem, the present disclosure provides a high-precision current source. As shown in FIG. 2, the high-precision current source includes: a reference voltage generation circuit 1 and a current generation circuit 2, where the reference voltage generation circuit 1 includes: a first operational amplifier U1, a first transistor Q1, and a zero temperature coefficient resistor circuit 3, and the zero temperature coefficient resistor circuit 3 can refer to a circuit in which the resistance values of resistors basically do not change with temperature or change very small with temperature. In addition, the reference voltage generation circuit 1 also includes an external circuit 4. The connection relationship of the reference voltage generation circuit is as follows: an inverting input terminal of the first operational amplifier U1 is connected to a bias voltage terminal, a non-inverting input terminal of the first operational amplifier U1 is connected to a first terminal of the zero temperature coefficient resistor circuit 3, an output terminal of the first operational amplifier U1 is connected to a first terminal of the first transistor Q1, and the first operational amplifier U1 is configured to obtain a bias voltage (VREF) of the bias voltage terminal and transmit the bias voltage to the zero temperature coefficient resistor circuit 3; a second terminal of the first transistor Q1 is connected to a power supply (VCC) of a chip, and a third terminal of the first transistor Q1 is connected to a second terminal of the zero temperature coefficient resistor circuit 3; a third terminal of the zero temperature coefficient resistor circuit 3 is connected to a signal control terminal, and a fourth terminal of the zero temperature coefficient resistor circuit 3 is connected to a first terminal of the current generation circuit 2, a second terminal of the current generation circuit 2 is connected to a corresponding external circuit 4, and the zero temperature coefficient resistor circuit 3 is configured to receive a control signal (TRIM<N:0>) sent by the signal control terminal, adjust the bias voltage (VREF) according to the control signal (TRIM<N:0>), and transmit the adjusted bias voltage (VREFOUT) to the current generation circuit 2, such that the current generation circuit 2 outputs the corresponding current according to the adjusted bias voltage (VREFOUT).

In a specific embodiment, the principle of the high-precision current source provided by the present disclosure is as follows: the first operational amplifier U1 obtains the bias voltage (VREF) and transmits the bias voltage (VREF) to the zero temperature coefficient resistor circuit 3 through the first transistor Q1, while receiving the bias voltage (VREF), the zero temperature coefficient resistor circuit 3 also receives the control signal (TRIM<N:0>) sent by the signal control terminal. The zero temperature coefficient resistor circuit 3 adjusts the bias voltage (VREF) according to the control signal (TRIM<N:0>) to obtain the adjusted bias voltage (VREFOUT), and then transmits the adjusted bias voltage to the current generation circuit 2, such that the current generation circuit 2 outputs the corresponding current to the corresponding external circuit 4 according to the adjusted bias voltage (VREFOUT).

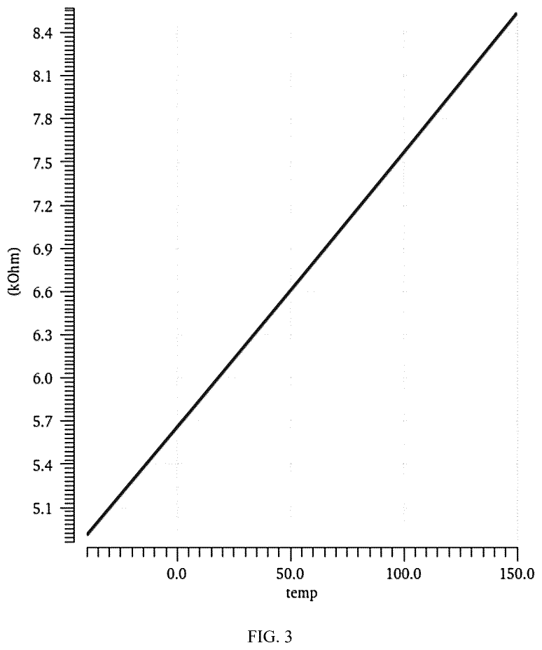

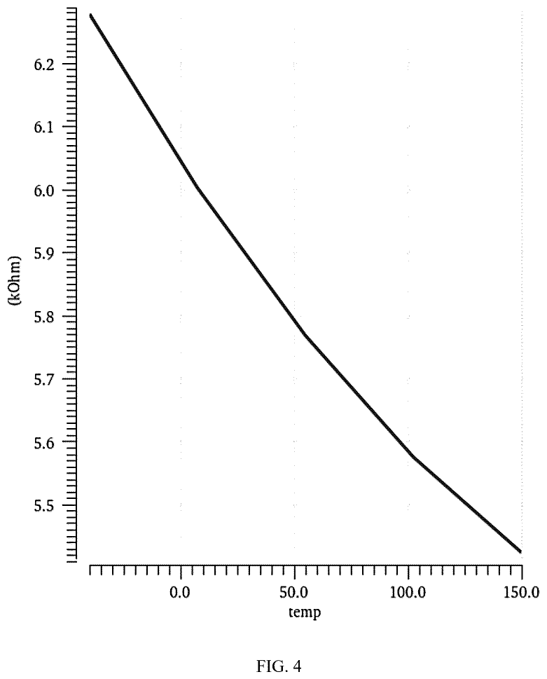

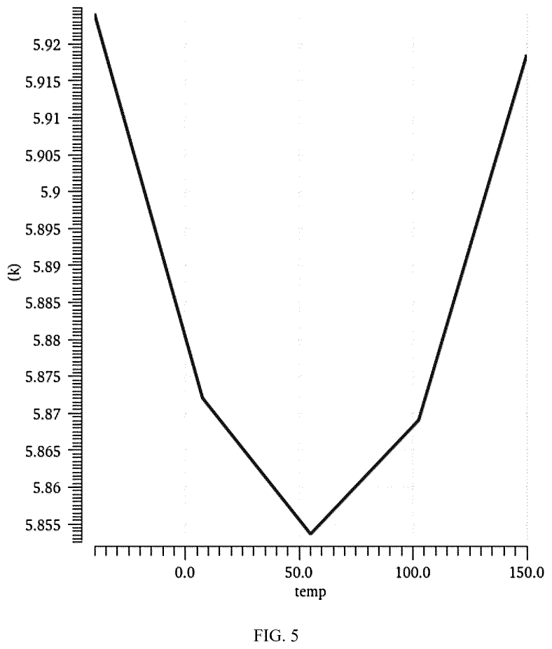

It should be noted that the reason why the zero temperature coefficient resistor circuit 3 used in the present disclosure adjusts its bias voltage (VREF) is as follows: the zero temperature coefficient resistor circuit 3 uses resistors with positive and negative temperature coefficients connected in series in proportion, thereby achieving the minimum change of the resistance value within the temperature range in which the circuit operates, and thus reducing the influence of temperature on the precision of the current source. FIGS. 3, 4, and 5 are simulation curves of resistance values of a positive temperature coefficient resistor, a negative temperature coefficient resistor, and the zero temperature coefficient resistor circuit 3 proposed in the present disclosure changing with temperature, respectively. It can be seen that the zero temperature coefficient resistor can control the change of the resistance value within a very small range. In FIGS. 3, 4 and 5, the horizontal axis temp represents the temperature, and the vertical axis kOhm represents the resistance value.

As a preferred option, the first transistor Q1 is a first P-type MOS transistor. The gate of the first P-type MOS transistor serves as the first terminal of the first transistor Q1 and is connected to the output terminal of the first operational amplifier U1, the source of the first P-type MOS transistor serves as the second terminal of the first transistor Q1 and is connected to the power supply VCC of the chip, the drain of the first P-type MOS transistor serves as the third terminal of the first transistor Q1 and is connected to the second terminal of the zero temperature coefficient resistor circuit 3.

The high-precision current source provided by the present disclosure includes: a reference voltage generation circuit and a current generation circuit, where the reference voltage generation circuit includes: a first operational amplifier, a first transistor, and a zero temperature coefficient resistor circuit; the inverting input terminal of the first operational amplifier is connected to the bias voltage terminal, the non-inverting input terminal of the first operational amplifier is connected to the first terminal of the zero temperature coefficient resistor circuit, the output terminal of the first operational amplifier is connected to the first terminal of the first transistor, and the first operational amplifier is configured to obtain the bias voltage of the bias voltage terminal and transmit the bias voltage to the zero temperature coefficient resistor circuit; the second terminal of the first transistor is connected to the power supply of the chip, and the third terminal of the first transistor is connected to the second terminal of the zero temperature coefficient resistor circuit; the third terminal of the zero temperature coefficient resistor circuit is connected to the signal control terminal, and the fourth terminal of the zero temperature coefficient resistor circuit is connected to the first terminal of the current generation circuit; the second terminal of the current generation circuit is connected to the corresponding external circuit, and is configured to receive the control signal sent by the signal control terminal, adjust the bias voltage according to the control signal, and transmit the adjusted bias voltage to the current generation circuit, such that the current generation circuit outputs the corresponding current according to the adjusted bias voltage. It can be seen that, in the present disclosure, it reduces the influence of chip manufacturing process and operating voltage on the precision of the current source by slightly adjusting the bias voltage, and it uses resistors with different temperature coefficients to form a zero temperature coefficient resistor, which reduces the problem of the drift of the output current due to the change of temperature, avoids the use of an external high-precision resistor and improves the precision of the current source.

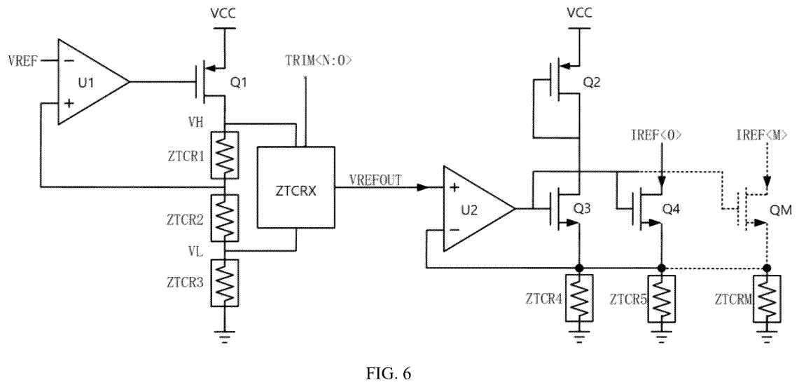

On the basis of the above embodiment, as a preferred embodiment, as shown in FIG. 6, the zero temperature coefficient resistor circuit 3 includes a first resistor module ZTCR1, a second resistor module ZTCR2, a third resistor module ZTCR3, and a resistor string module ZTCRX. The connection relationship of these modules is as follows: a first terminal of the first resistor module ZTCR1 is connected to a first terminal of the resistor string module ZTCRX, and they jointly serve as the second terminal of the zero temperature coefficient resistor circuit 3 and are connected to the third terminal of the first transistor Q1; a second terminal of the first resistor module ZTCR1 is connected to a first terminal of the second resistor module ZTCR2, and they jointly serve as the first terminal of the zero temperature coefficient resistor circuit 3 and are connected to the non-inverting input terminal of the first operational amplifier U1; a second terminal of the second resistor module ZTCR2 is connected to a first terminal of the third resistor module ZTCR3 and a second terminal of the resistor string module ZTCRX; a second terminal of the third resistor module ZTCR3 is grounded; a third terminal of the resistor string module ZTCRX serves as the third terminal of the zero temperature coefficient resistor circuit 3 and is connected to the signal control terminal, and a fourth terminal of the resistor string module ZTCRX serves as the fourth terminal of the zero temperature coefficient resistor circuit 3 and is connected to the first terminal of the current generation circuit 2.

As a preferred option, the resistor string module includes N resistor modules with the same structure. The circuit connection relationship of these resistor modules is as follows: a first terminal of an initial resistor module serves as the first terminal of the resistor string module and is connected to the first terminal of the first resistor module; a first terminal of a Xth resistor module is connected to a second terminal of a (X−1)th resistor module; a second terminal of a Nth resistor module serves as the second terminal of the resistor string module and is connected to the second terminal of the second resistor module and the first terminal of the third resistor module; a third terminal of each resistor module serves as the third terminal of the resistor string module and is connected to the signal control terminal, such that each resistor module can determine the corresponding target resistor module according to the control signal sent by the signal control terminal, and connect a fourth terminal of the target resistor module which serves as the fourth terminal of the resistor string module, to the first terminal of the current generation circuit; where N is an integer greater than 0, and X is an integer greater than 1 and less than N.

In a specific embodiment, according to the circuit shown in FIG. 6, the circuit principle is as follows: one terminal of the resistor string module ZTCRX is connected between the first resistor module ZTCR1 and the first transistor Q1, and another terminal is connected between the second resistor module ZTCR2 and the third resistor module ZTCR3. One of several output ports in the resistor string module is selected to output the adjusted bias voltage (VREFOUT) according to its control signal (TRIM<N:0>). The value of the adjusted bias voltage (VREFOUT) is between the highest voltage value VH and the lowest voltage value VL, where the highest voltage value VH is the voltage value between the first resistor module ZTCR1 and the first transistor Q1, and the lowest voltage value VL is the voltage value between the second resistor module ZTCR2 and the third resistor module ZTCR3. That is to say, the resistor string module ZTCRX includes N resistor modules with the same structure, the third terminal of each resistor module is configured to receive the control signal (TRIM<N:0>). In the entire resistor string module ZTCRX, under the selection of the control signal, one of the resistor modules is selected as the target resistor module. At this time, the fourth terminal of the selected resistor module (i.e., target resistor module) serves as the fourth terminal of the resistor string module and is connected to the first terminal of the current generation circuit, so as to achieve the purpose of adjusting the bias voltage (VREF) according to the control signal (TRIM<N:0>). It should be clearly noted that each resistor module has a fourth terminal, and only in the case that the resistor module is selected as the target resistor module, its fourth terminal serves as the fourth terminal of the resistor string module and is connected to the first terminal of the current generation circuit.

As a preferred option, the resistor modules in the first resistor module ZTCR1, the second resistor module ZTCR2, the third resistor module ZTCR3, and the resistor string module ZTCRX have the same structure, and are all formed by resistors with positive and negative temperature coefficients proportionally connected in series.

Based on the above embodiments, the current generation circuit 2 includes a target current circuit and a mirror current circuit. The connection relationship of these circuits is as follows: a first terminal of the target current circuit serves as the first terminal of the current generation circuit and is connected to the fourth terminal of the zero temperature coefficient resistor circuit; a second terminal of the target current circuit is connected to a first terminal of the mirror current circuit; and a second terminal of the mirror current circuit serves as the second terminal of the current generation circuit and is connected to the corresponding external circuit.

As a preferred option, as shown in FIG. 6, the target current circuit includes: a second operational amplifier U2, a second transistor Q2, a third transistor Q3, and a fourth resistor module ZTCR4. Their connection relationship is as follows: a first terminal of the second transistor Q2 is connected to the power supply VCC of the chip, and a second terminal of the second transistor Q2 is connected to a third terminal of the second transistor Q2 and a first terminal of the third transistor Q3; a non-inverting input terminal of the second operational amplifier U2 serves as the first terminal of the target current circuit and is connected to the fourth terminal of the zero temperature coefficient resistor circuit 3; an inverting input terminal of the second operational amplifier U2 is connected to a second terminal of the third transistor Q3 and a first terminal of the fourth resistor module ZTCR4; an output terminal of the second operational amplifier U2 is connected to a third terminal of the third transistor Q3, and they jointly serve as the second terminal of the target circuit current and are connected to the first terminal of the mirror current circuit; and a second terminal of the fourth resistor module ZTCR4 is grounded.

As a preferred option, the mirror current circuit includes M mirror circuits with the same structure, where M is an integer greater than 1. The connection relationship of the mirror circuits is as follows: first terminals of the mirror circuits are connected to each other, serve as the first terminal of the mirror current circuit and are connected to the second terminal of the target current circuit; and second terminals of the mirror circuits serve as the second terminal of the mirror current circuit and are respectively connected to a corresponding external circuit. As shown in FIG. 6, where the number of mirror circuits in FIG. 6 being two is taken as an example. For the first mirror circuit, the mirror circuit includes Q4 and ZTCR5, where a first terminal of Q4 serves as the first terminal of the mirror circuit and is connected to the second terminal of the target current circuit, a second terminal of Q4 serves as the second terminal of the mirror circuit and is connected to a corresponding external circuit and the output current is IREF<0>, and a third terminal of Q4 is connected to a first terminal of ZTCR5; and a second terminal of ZTCR5 is grounded. For the Mth mirror circuit, the mirror circuit includes QM and ZTCRM, where a first terminal of QM serves as the first terminal of the mirror circuit and is connected to the second terminal of the target current circuit, a second terminal of QM serves as the second terminal of the mirror circuit and is connected to a corresponding external circuit and the output current is IREF<M>, and a third terminal of QM is connected to the first terminal of ZTCRM; and a second terminal of ZTCRM is grounded.

The second transistor Q2 is a second P-type MOS transistor; the third transistor Q3 is a first N-type MOS transistor; and the fourth transistor Q4 is a second N-type MOS transistor. The circuit connection relationship of these transistors is as follows: the source of the second P-type MOS transistor serves as the first terminal of the second transistor Q2 and is connected to the power supply VCC of the chip, and the gate of the second P-type MOS transistor which serves as the second terminal of the second transistor Q2 is connected to the drain of the second P-type MOS transistor which serves as the third terminal of the second transistor Q2; the drain of the first N-type MOS transistor serves as the first terminal of the third transistor Q3 and is connected to the gate of the second P-type MOS transistor, the gate of the first N-type MOS transistor serves as the third terminal of the third transistor Q3 and is connected to the output terminal of the second operational amplifier U2, and the source of the first N-type MOS transistor serves as the second terminal of the third transistor Q3 and is connected to the first terminal of the fourth resistor module ZTCR4. The gate of the second N-type MOS transistor serves as the first terminal of the fourth transistor Q4 (QM) and is connected to the second terminal of the target current circuit, the source of the second N-type MOS transistor serves as the second terminal of the fourth transistor Q4 (QM) and is connected to the corresponding external circuit 4, and the drain of the second N-type MOS transistor serves as the third terminal of the fourth transistor Q4 (QM) and is connected to the first terminal of the fifth resistor module ZTCR5 (ZTCRM).

In the circuit shown in FIG. 6, the current generation circuit 2 is composed of U2, Q2, Q3, Q4, QM, ZTCR4, ZTCR5, and ZTCRM, and can be expanded on the basis of the dotted line part shown in the figure according to the number of external circuits. The adjusted bias voltage (VREFOUT) generated by the reference voltage generation circuit 1 serves as the clamping voltage of the current generation circuit 2. High-precision reference current (i.e., the output current) is generated through U2, Q2, Q3, and ZTCR4. Q4 and ZTCR5 (including the expandable QM and ZTCRM) are used to mirror this reference current. The size ratio of Q4 to Q3 and the size ratio of ZTCR5 to ZTCR4 need to be maintained at 1:1, so as to ensure the mirroring precision.

It should be noted that the embodiments provided in the present disclosure are merely one type of implementable embodiments and can be configured according to user needs.

It can be seen that, in the present disclosure, it reduces the influence of chip manufacturing process and operating voltage on the precision of the current source by slightly adjusting the bias voltage, and it uses resistors with different temperature coefficients to form a zero temperature coefficient resistor, which reduces the problem of the drift of the output current due to the change of temperature, avoids the use of an external high-precision resistor and improves the precision of the current source.

To solve the above technical problem, the present disclosure also provides an electronic device. The electronic device includes the above high-precision current source and has the same beneficial effects. The specific embodiments thereof are the same as those of the above high-precision current source, and will not be repeated in the present disclosure.

The high-precision current source and the electronic device provided by the present disclosure are described in detail above. Various embodiments in the specification are described in a progressive manner. Each embodiment focuses on the differences from other embodiments, and the same or similar parts between the various embodiments can be referred to each other. Regarding the device disclosed in the embodiments, since it corresponds to the method disclosed in the embodiments, the description is relatively simple, and the relevant part can be referred to the description of the corresponding part in the method. It should be noted that, for those skilled in the art, several improvements and modifications can be made to the present disclosure without departing from the principle of the present disclosure, and these improvements and modifications also fall within the protection scope of the claims of the present disclosure.

It should also be noted that, in this specification, relational terms such as “first” and “second” are only used to distinguish one entity or operation from another entity or operation, and do not necessarily require or imply any such actual relationship or order between these entities or operations. Moreover, the terms “comprise/include,” “contain” or any other variants thereof are intended to cover non-exclusive inclusion, such that a process, method, article or device that includes a series of elements not also includes those elements, but also includes other elements not explicitly listed, or elements inherent to such process, method, article or device. Without further limitation, an element defined by the statement “comprise/include a . . . ” does not exclude the presence of any additional identical element in the process, method, article or device that includes the recited elements.

1. A high-precision current source, comprising: a reference voltage generation circuit and a current generation circuit, wherein the reference voltage generation circuit comprises: a first operational amplifier, a first P-type MOS transistor, and a zero temperature coefficient resistor circuit;
an inverting input terminal of the first operational amplifier is connected to a bias voltage terminal, a non-inverting input terminal of the first operational amplifier is a first terminal of the zero temperature coefficient resistor circuit, an output terminal of the first operational amplifier is connected to a gate of the first P-type MOS transistor, and the first operational amplifier is configured to obtain a bias voltage of the bias voltage terminal and transmit the bias voltage to the zero temperature coefficient resistor circuit;
a source of the first P-type MOS transistor is connected to a power supply of a chip, and a drain of the first P-type MOS transistor is connected to a second terminal of the zero temperature coefficient resistor circuit; and
a third terminal of the zero temperature coefficient resistor circuit is connected to a signal control terminal, and a fourth terminal of the zero temperature coefficient resistor circuit is connected to a first terminal of the current generation circuit, a second terminal of the current generation circuit is connected to a corresponding external circuit, and the zero temperature coefficient resistor circuit is configured to receive a control signal sent by the signal control terminal, adjust the bias voltage according to the control signal, and transmit the adjusted bias voltage to the current generation circuit, such that the current generation circuit outputs a corresponding current according to the adjusted bias voltage,
wherein the zero temperature coefficient resistor circuit comprises a first resistor module, a second resistor module, a third resistor module, and a resistor string module;
a first terminal of the first resistor module is connected to a first terminal of the resistor string module, and the first terminal of the first resistor module and the first terminal of the resistor string module jointly serve as the second terminal of the zero temperature coefficient resistor circuit and are connected to the drain of the first P-type MOS transistor; a second terminal of the first resistor module is connected to a first terminal of the second resistor module, and the second terminal of the first resistor module and the first terminal of the second resistor module jointly serve as the first terminal of the zero temperature coefficient resistor circuit and are connected to the non-inverting input terminal of the first operational amplifier;
a second terminal of the second resistor module is connected to a first terminal of the third resistor module and a second terminal of the resistor string module;
a second terminal of the third resistor module is grounded; and
a third terminal of the resistor string module serves as the third terminal of the zero temperature coefficient resistor circuit and is connected to the signal control terminal, and a fourth terminal of the resistor string module serves as the fourth terminal of the zero temperature coefficient resistor circuit and is connected to the first terminal of the current generation circuit;
wherein the resistor string module comprises N resistor modules with the same structure;
a first terminal of an initial resistor module in the N resistor modules serves as the first terminal of the resistor string module and is connected to the first terminal of the first resistor module;
a first terminal of a Xth resistor module is connected to a second terminal of a (X−1)th resistor module in the N resistor modules;
a second terminal of a Nth resistor module in the N resistor modules serves as the second terminal of the resistor string module and is connected to the second terminal of the second resistor module and the first terminal of the third resistor module;
a third terminal of each of the N resistor modules serves as the third terminal of the resistor string module and is connected to the signal control terminal, such that each of the N resistor modules determines a corresponding target resistor module according to the control signal sent by the signal control terminal, and connects a fourth terminal of the target resistor module serving as the fourth terminal of the resistor string module to the first terminal of the current generation circuit;
wherein N is an integer greater than 0, and X is an integer greater than 1 and less than N.

2-3. (canceled)

4. The high-precision current source according to claim 1, wherein the current generation circuit comprises a target current circuit and a mirror current circuit;
a first terminal of the target current circuit serves as the first terminal of the current generation circuit and is connected to the fourth terminal of the zero temperature coefficient resistor circuit; a second terminal of the target current circuit is connected to a first terminal of the mirror current circuit; and
a second terminal of the mirror current circuit serves as the second terminal of the current generation circuit and is connected to the corresponding external circuit.

5. The high-precision current source according to claim 4, wherein the target current circuit comprises: a second operational amplifier, a second P-type MOS transistor, a first N-type MOS transistor, and a fourth resistor module;
a source of the second P-type MOS transistor is connected to the power supply of the chip, and a gate of the second P-type MOS transistor is connected to a drain of the second P-type MOS transistor and a drain of the first N-type MOS transistor;
a non-inverting input terminal of the second operational amplifier serves as the first terminal of the target current circuit and is connected to the fourth terminal of the zero temperature coefficient resistor circuit; an inverting input terminal of the second operational amplifier is connected to a source of the first N-type MOS transistor and a first terminal of the fourth resistor module; an output terminal of the second operational amplifier is connected to a gate of the first N-type MOS transistor, and the output terminal of the second operational amplifier and the gate of the first N-type MOS transistor jointly serve as the second terminal of the target current circuit and are connected to the first terminal of the mirror current circuit; and
a second terminal of the fourth resistor module is grounded.

6. The high-precision current source according to claim 4, wherein the mirror current circuit comprises M mirror circuits with the same structure, and each mirror circuit of the mirror circuits comprises a first terminal and a second terminal, M being an integer greater than 1;
first terminals of the mirror circuits are connected to each other, serve as the first terminal of the mirror current circuit and are connected to the second terminal of the target current circuit; and
second terminals of the mirror circuits serve as the second terminal of the mirror current circuit and are respectively connected to a corresponding external circuit.

7. The high-precision current source according to claim 6, wherein the mirror circuit comprises: a second N-type MOS transistor and a fifth resistor module;
a gate of the second N-type MOS transistor serves as the first terminal of the mirror circuit and is connected to the second terminal of the target current circuit, a source of the second N-type MOS transistor serves as the second terminal of the mirror circuit and is connected to a corresponding external circuit, and a drain of the second N-type MOS transistor is connected to a first terminal of the fifth resistor module; and
a second terminal of the fifth resistor module is grounded.

8-9. (canceled)

10. An electronic device, comprising a high-precision current source, wherein the high-precision current source comprising: a reference voltage generation circuit and a current generation circuit, wherein the reference voltage generation circuit comprises: a first operational amplifier, a first P-type MOS transistor, and a zero temperature coefficient resistor circuit;
an inverting input terminal of the first operational amplifier is connected to a bias voltage terminal, a non-inverting input terminal of the first operational amplifier is a first terminal of the zero temperature coefficient resistor circuit, an output terminal of the first operational amplifier is connected to a gate of the first P-type MOS transistor, and the first operational amplifier is configured to obtain a bias voltage of the bias voltage terminal and transmit the bias voltage to the zero temperature coefficient resistor circuit;
a source of the first P-type MOS transistor is connected to a power supply of a chip, and a drain of the first P-type MOS transistor is connected to a second terminal of the zero temperature coefficient resistor circuit; and
a third terminal of the zero temperature coefficient resistor circuit is connected to a signal control terminal, and a fourth terminal of the zero temperature coefficient resistor circuit is connected to a first terminal of the current generation circuit, a second terminal of the current generation circuit is connected to a corresponding external circuit, and the zero temperature coefficient resistor circuit is configured to receive a control signal sent by the signal control terminal, adjust the bias voltage according to the control signal, and transmit the adjusted bias voltage to the current generation circuit, such that the current generation circuit outputs a corresponding current according to the adjusted bias voltage,
wherein the zero temperature coefficient resistor circuit comprises a first resistor module, a second resistor module, a third resistor module, and a resistor string module;
a first terminal of the first resistor module is connected to a first terminal of the resistor string module, and the first terminal of the first resistor module and the first terminal of the resistor string module jointly serve as the second terminal of the zero temperature coefficient resistor circuit and are connected to the drain of the first P-type MOS transistor; a second terminal of the first resistor module is connected to a first terminal of the second resistor module, and the second terminal of the first resistor module and the first terminal of the second resistor module jointly serve as the first terminal of the zero temperature coefficient resistor circuit and are connected to the non-inverting input terminal of the first operational amplifier;
a second terminal of the second resistor module is connected to a first terminal of the third resistor module and a second terminal of the resistor string module;
a second terminal of the third resistor module is grounded; and
a third terminal of the resistor string module serves as the third terminal of the zero temperature coefficient resistor circuit and is connected to the signal control terminal, and a fourth terminal of the resistor string module serves as the fourth terminal of the zero temperature coefficient resistor circuit and is connected to the first terminal of the current generation circuit;
wherein the resistor string module comprises N resistor modules with the same structure;
a first terminal of an initial resistor module in the N resistor modules serves as the first terminal of the resistor string module and is connected to the first terminal of the first resistor module;
a first terminal of a Xth resistor module is connected to a second terminal of a (X−1)th resistor module in the N resistor modules;
a second terminal of a Nth resistor module in the N resistor modules serves as the second terminal of the resistor string module and is connected to the second terminal of the second resistor module and the first terminal of the third resistor module;
a third terminal of each of the N resistor modules serves as the third terminal of the resistor string module and is connected to the signal control terminal, such that each of the N resistor modules determines a corresponding target resistor module according to the control signal sent by the signal control terminal, and connects a fourth terminal of the target resistor module serving as the fourth terminal of the resistor string module to the first terminal of the current generation circuit;
wherein N is an integer greater than 0, and X is an integer greater than 1 and less than N.

11. The electronic device according to claim 10, wherein the current generation circuit comprises a target current circuit and a mirror current circuit;
a first terminal of the target current circuit serves as the first terminal of the current generation circuit and is connected to the fourth terminal of the zero temperature coefficient resistor circuit; a second terminal of the target current circuit is connected to a first terminal of the mirror current circuit; and
a second terminal of the mirror current circuit serves as the second terminal of the current generation circuit and is connected to the corresponding external circuit.

12. The electronic device according to claim 11, wherein the target current circuit comprises: a second operational amplifier, a second P-type MOS transistor, a first N-type MOS transistor, and a fourth resistor module;
a source of the second P-type MOS transistor is connected to the power supply of the chip, and a gate of the second P-type MOS transistor is connected to a drain of the second P-type MOS transistor and a drain of the first N-type MOS transistor;
a non-inverting input terminal of the second operational amplifier serves as the first terminal of the target current circuit and is connected to the fourth terminal of the zero temperature coefficient resistor circuit; an inverting input terminal of the second operational amplifier is connected to a source of the first N-type MOS transistor and a first terminal of the fourth resistor module; an output terminal of the second operational amplifier is connected to a gate of the first N-type MOS transistor, and the output terminal of the second operational amplifier and the gate of the first N-type MOS transistor jointly serve as the second terminal of the target current circuit and are connected to the first terminal of the mirror current circuit; and
a second terminal of the fourth resistor module is grounded.

13. The electronic device according to claim 11, wherein the mirror current circuit comprises M mirror circuits with the same structure, and each mirror circuit of the mirror circuits comprises a first terminal and a second terminal, M being an integer greater than 1;
first terminals of the mirror circuits are connected to each other, serve as the first terminal of the mirror current circuit and are connected to the second terminal of the target current circuit; and
second terminals of the mirror circuits serve as the second terminal of the mirror current circuit and are respectively connected to a corresponding external circuit.

14. The electronic device according to claim 13, wherein the mirror circuit comprises: a second N-type MOS transistor and a fifth resistor module;
a gate of the second N-type MOS transistor serves as the first terminal of the mirror circuit and is connected to the second terminal of the target current circuit, a source of the second N-type MOS transistor serves as the second terminal of the mirror circuit and is connected to a corresponding external circuit, and a drain of the second N-type MOS transistor is connected to a first terminal of the fifth resistor module; and
a second terminal of the fifth resistor module is grounded.
